(19) United States
(12) Patent Application Publication
(10) Pub. No.: US 2025/0096284 A1
(43) Pub. Date: Mar. 20, 2025

(54) SOLID OXIDE ELECTROCHEMICAL DEVICE UNIT CELL

(71) Applicant: NISSAN NORTH AMERICA, INC., Franklin, TN (US)

(72) Inventor: Mohammed Hussain ABDUL JABBAR, Farmington Hills, MI (US)

(21) Appl. No.: 18/470,322

(22) Filed: Sep. 19, 2023

(51) Int. Cl. H01M 8/0271; H01M 8/0202; H01M 8/0612; H01M 8/12; H01M 8/1213; H01M 8/1246

(52) U.S. Cl. CPC H01M 8/0271; H01M 8/0202; H01M 8/0618; H01M 8/1213; H01M 8/1246; H01M 2008/1293

(57) ABSTRACT

A solid oxide electrochemical device unit cell includes a first current collector layer, a first cathode, a first top welding section and a second cathode. The first cathode layered is with respect to the first current collector layer in a stacking direction of the solid oxide electrochemical device. The first top welding section extends around an outer circumferential perimeter of the first cathode. The top welding section has at least one welding point that is welded to the first current collector. The second cathode is coplanar with the first cathode in the stacking direction. The top welding section is located between the first and second cathodes.

### BACKGROUND

### Technical Field

The present disclosure generally relates to a solid oxide electrochemical device unit cell. More specifically, the present disclosure relates to solid oxide electrochemical device unit cell having an open cathode structure.

### Background Information

Conventionally, solid oxide fuel cells are classified into the following types: so-called electrolyte-supported cells, wherein a plate-like electrolyte is used as a support, and a anode is formed on one surface of the electrolyte, and an cathode is formed on the other surface of the electrolyte. That is, so-called electrode-supported cells, wherein one of the anode or cathode is used as a support, and the electrolyte and other electrode are formed in order on the support and the like.

### SUMMARY

In view of the state of the known technology, one aspect of the present disclosure is to provide a cathode structure for use in a solid oxide electrochemical device. The cathode structure comprises a first cathode, a second cathode, and a first welding section. The first cathode has a center point of the solid oxide fuel cell as viewed in a stacking direction of the solid oxide electrochemical device. The second cathode is concentrically arranged with respect to the first cathode as viewed in the stacking direction. The first welding section is arranged radially between the first cathode and the second cathode with respect to the center point of the solid oxide electrochemical device. The first welding section extends around an outer circumferential perimeter of the first cathode. The first welding section is configured to be welded to a current collector of the solid oxide electrochemical device.

In view of the state of the known technology, another aspect of the present disclosure is to provide a solid oxide electrochemical device unit cell includes a first current collector layer, a first cathode, a first top welding section and a second cathode. The first cathode layered is with respect to the first current collector layer in a stacking direction of the solid oxide electrochemical device. The first top welding section extends around an outer circumferential perimeter of the first cathode. The top welding section has at least one welding point that is welded to the first current collector. The second cathode is coplanar with the first cathode in the stacking direction. The top welding section is located between the first and second cathodes.

In view of the state of the known technology, another aspect of the present disclosure is to provide a solid oxide electrochemical device. The solid oxide electrochemical device comprising a first current collector layer, a cathode, a top welding section, an electrolyte layer and a seal gap. The cathode is layered with respect to the current collector layer in a stacking direction of the solid oxide electrochemical device. The top welding section extends around an outer circumferential perimeter of the first cathode. The top welding section has at least one welding point that is welded to the first current collector. The electrolyte layer is layered with respect to the first cathode in the stacking direction. The seal gap is located adjacent to and coplanar with the first current collector layer in the stacking direction. The seal gap is layered with respect to the electrolyte layer.

### BRIEF DESCRIPTION OF THE DRAWINGS

Referring now to the attached drawings which form a part of this original disclosure:

FIG. 1 is a cross-sectional view of a solid oxide electrochemical device unit cell in accordance with an illustrated embodiment;

FIG. 2 is a top view of the solid oxide electrochemical device unit cell of FIG. 1 with a top current collector layer removed;

FIG. 3 is a top view of a modified version of the solid oxide electrochemical device unit cell;

FIG. 4 is a solid oxide electrochemical device that can be modified to be implemented with the unit cell of FIG. 1;

FIG. 5 is a schematic diagram of a voltage output of the solid oxide electrochemical device; and

FIG. 6 is a schematic diagram of the output of the solid oxide electrochemical device.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

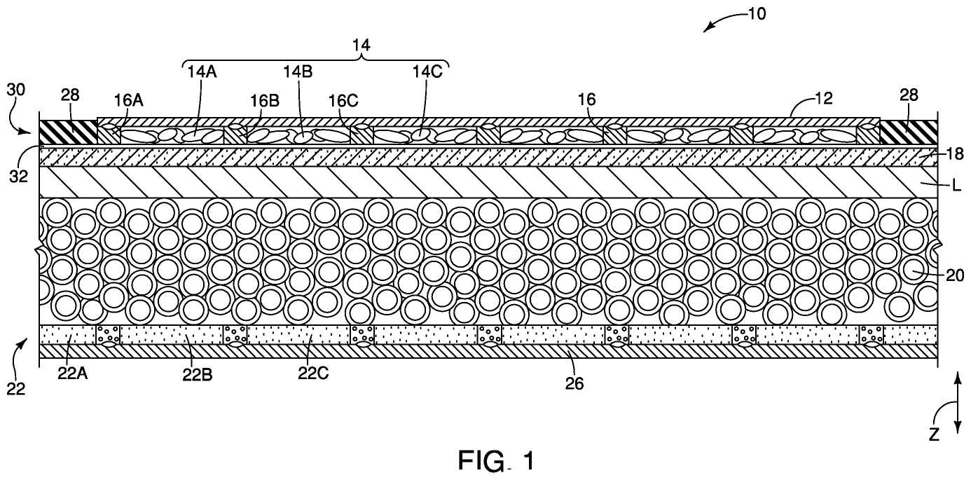

Referring initially to FIG. 1, a solid oxide electrochemical device unit cell 10 (hereinafter “unit cell 10”) is illustrated in accordance with an embodiment. The unit cell 10 comprises a first (top) current collector layer 12, a first cathode 14A, a top welding section 16 and at least one additional cathode 14. As shown, the unit cell 10 further comprises a second cathode 14B and an electrolyte layer 18. The unit cell 10 further comprises an anode layer 20, a reforming catalyst section 22, a bottom welding section 24, and a second (bottom) current collector layer 24. The above-mentioned components of the unit cell 10 are arranged in a stacking direction Z in which the first current collector layer 12 is considered a top layer of the unit cell 10 and the second current collector layer 26 is considered a bottom layer of the unit cell 10. The first and second cathodes 14A and 14B and the top welding section 16 are arranged co-planar with respect to each other and are all layered with respect to the first current collector layer 12 in the stacking direction Z towards the second current collector layer 26. That is, the first and second cathodes 14A and 14B and the top welding section 16 are arranged between the first and second current collectors along the stacking direction Z.

The electrolyte layer 18 is layered with respect to the first and second cathodes 14A and 14B and the top welding section 16 in the stacking direction Z towards the second current collector layer 26. The anode layer 20 is layered with respect to the electrolyte layer 18 in the stacking direction Z towards the second current collector layer 26. The reforming catalyst section 22 and bottom welding section 24 are arranged co-planar with respect to each other and are layered with respect to the anode layer 20 in the stacking direction Z towards the second current collector layer 26. That is, the electrolyte layer 18, the anode layer 20, the reforming catalyst section 22 and the bottom welding section 24 are arranged between the first and second current collector layers 12 and 26 along the stacking direction Z.

As shown, the unit cell 10 further comprises a pair of seals 28 arranged co-planar with the top welding section 16, as will be described below. The arrangement of the claimed unit cell 10 enables for a pair of seals 28 to be arranged to prevent gas from escaping from the unit cell 10 to other unit cells that are used in conjunction with the unit cell 10 or to be stacked with the unit cell 10. The arrangement of the claimed unit cell 10 also enables for an open cathode sealable design that allows for the cathodes 14 to be exposed to the external environment and to be more concentrated such to facilitate faster reactions.

In the illustrated embodiment, the unit cell 10 of the illustrated embodiment comprises a cathode structure 30 for use in a solid oxide electrochemical device of the unit cell 10. The cathode structure 30 comprises at least the first cathode 14A and the second cathode 14B. The cathode structure 30 further comprises the top welding section 16.

The unit cell 10 of the illustrated embodiment is provided as comprising compact battery-like fuel cells that prevents fuel (e.g., hydrogen, propane and natural gas, etc.) and airflow from intermixing. The unit cell 10 is designed to comprise of a series of solid oxide electrochemical devices that are to be conveniently stacked and to be portable like current batteries in vehicles.

As stated, the first current collector layer 12 defines the top layer of the unit cell 10. The second current collector layer 26 defines the bottom layer of the unit cell 10. The current collectors provide the fuel and the oxidant supply to the electrons collection on the anode side and the conduction thereof to the cathode side. The current collectors also serve to provide structural support to the unit cell 10 and allow for products removal from the unit cell 10. Therefore, the current collector layers 12 and 26 are provided to be small, compact, low cost and decreased height and while possessing high durability and power. The current collectors are preferably made of materials that have high electrical conductivity, corrosion resistance and mechanical strength, low weight and cost and a simpler design (easy to manufacture). The current collector layers 12 and 26 can also be made of stainless steel, aluminum, titanium, and printed board circuits.

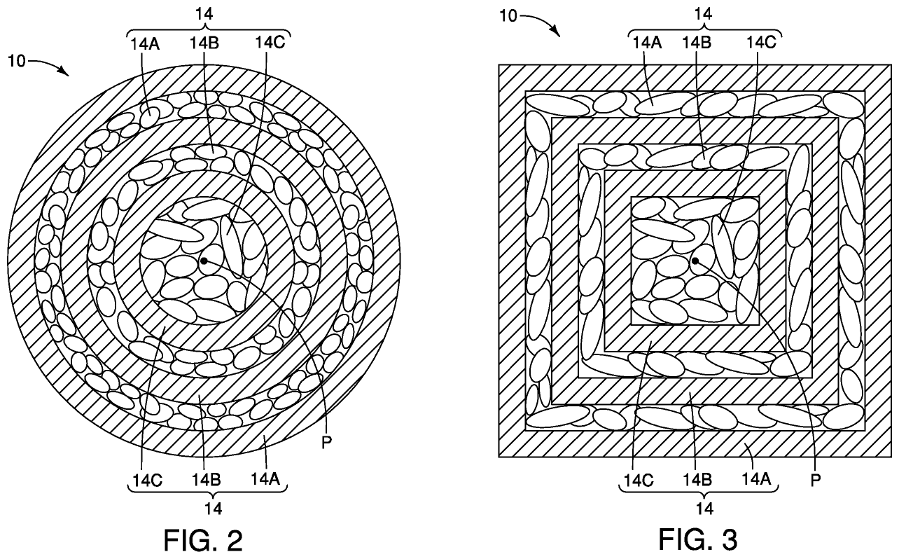

The first cathode 14A is layered with respect to the first current collector layer 12 in a stacking direction Z of the solid oxide electrochemical device. In the illustrated embodiment, the unit cell 10 includes a series of cathodes 14 that are co-planar with the first cathode 14A and are layered with respect to the first current collector layer 12. That is, the unit cell 10 includes the second and third cathodes 14B and 14C that are co-planar with the first cathode 14A. As best seen in FIGS. 2 and 3, the first cathode 14A has a center point of the solid oxide fuel cell as viewed in the stacking direction Z of the solid oxide electrochemical device.

In the illustrated embodiment, the unit cell 10 includes a plurality of cathodes 14 that are co-planar with each other and are stacked underneath the first current collector layer 12. It will be apparent to those skilled in the fuel cell field from this disclosure that the plurality of cathodes 14 can include a various number of cathodes 14 as needed and or desired. In the illustrated embodiment, the unit cell 10 includes a series of welding sections 16A, 16B, 16C, etc. that are part of the top welding section 16. Each of the welding sections 16A, 16B, 16C, etc. are arranged between the cathodes 14 in the radial direction as seen in FIGS. 2 and 3. The unit cell 10 can include, for example, the first top welding section 16, a second top welding section 16, a third top welding section 16, etc. Therefore, it will be further apparent to those skilled in the fuel cell art from this disclosure that the welding sections 16 can include a various number of welding sections 16 that are positioned between adjacent ones of the cathodes 14, as will be further described below.

In particular, referring back to FIG. 1, the second cathode 14B is coplanar with the first cathode 14A with respect to the stacking direction Z. The first top welding section 16 is located between the first and second cathodes 14A and 14B. As seen in FIGS. 2 and 3, the second cathode 14B is concentrically arranged with respect to the first cathode 14A from the center point of the unit cell 10. In other words, the second cathode 14B is concentrically arranged with respect to the first cathode 14A as viewed in the stacking direction Z. Also as shown, the second cathode 14B extends around an outer circumferential perimeter of the first top welding section 16. That is, the second cathode 14B encircles the first top welding section 16A that is positioned between the first and second cathodes 14A and 14B. As shown, the unit cell 10 comprises a third cathode 14C that is arranged concentrically with respect to the first and second cathodes 14A and 14B as viewed in the stacking direction Z. The third cathode 14C extends around an outer circumferential perimeter of the second welding section 16B. That is, the third cathode 14C encircles the second top welding section 16B. The second top welding section 16B is positioned between the second and third cathodes 14B and 14C.

The cathodes 14 are preferably made of ceramic such as LaSrCoO. Examples of ceramic powder materials that can be used to form the cathode 14 include metal oxides made of Co, Fe, Ni, Cr, Mn, and the like with the perovskite or a like structure. More specifically, oxides such as (Sm, Sr)CoO₃, (La, Sr)MnO₃, (La, Sr)CoO₃, (La, Sr)(Fe, Co)O₃, (La, Sr)(Fe, Co, Ni)O₃, and the like are usable, with (La, Sr)(Fe, Co)O₃ being preferred. These ceramic materials can be used alone, or two or more of them can be used as a mixture.

The cathodes 14 can be made from a low temperature material that sinters at a temperature of 850° C. or less in air. For example, the cathodes 14 can be samarium strontium cobalt oxide (SSC), having the formula SrSmCoO₃, PrBaSrCoFeO, or any suitable perovskite oxide having the general formula ABO₃. Other non-limiting examples of materials that can be used as the cathodes include perovskite cathodes, (La_{0.8}Sr_{0.2})_{0.95} MnO₃ (LSM), La_{0.6}Sr_{0.4}CoO₃ (LSC), Sr_{0.5}Sm_{0.5}O₃ (SSC), Ba_{0.5}Sr_{0.5}Co_{0.8}Fe_{0.2}O₃ (BSCF), (La_{0.6}Sr_{0.4})_{0.95} (Co_{0.2}Fe_{0.8})O₃ (LSCF), and PrBa_{0.5}Sr_{0.5}Co_{1.5}Fe_{0.5}O_{5+y} (PBSCF) with and without GDC, a ceria based doped material. The cathodes 14 can be formed via electrophoretic deposition (EPD) of the materials mentioned onto the surface of the electrolyte layer 18. In this way, the cathodes 14 can be formed to have a small thickness.

As stated, the top welding section 16 includes a plurality of welding sections such as the first, second and third welding sections 16A, 16B and 16C. It will be apparent to those skilled in the fuel cell art from this disclosure that the top welding section 16 can include various numbers of individual sections that are interspersed between the cathodes 14. In the illustrated embodiment, the top welding section 16 is a porous stainless steel section. That is, the first, second and third top welding sections 16A, 16B and 16C are made of porous stainless steel. Therefore, each of the cathodes 14 of the unit cell 10 are surrounded by a layer of porous stainless steel comprising the top welding section 16. The top welding section 16 is provided on the cathode side of the unit cell 10 and are provided to weld the electrolyte layer 18 to the first current collector, as will be described below. Therefore, the top welding section 16 is provided so that the cathodes 14 can be connected to the first current collector layer 12 via the top welding section 16.

As seen in FIG. 2, the first top welding section 16 extends around an outer circumferential perimeter of the first cathode 14A. The first top welding section 16 has at least one welding point that is welded to the first current collector. In other words, the first welding section is configured to be welded to the first current collector of the unit cell 10. The first top welding section 16 is arranged radially between the first cathode 14A and the second cathode 14B with respect to the center point of the unit cell 10.

The second top welding section 16 extends around an outer circumferential perimeter of the second cathode 14B and is configured to be welded to the first current collector. The second top welding section 16 is arranged radially between the first and second cathodes 14A and 14B with respect to the center point of the unit cell 10. As seen in FIG. 2, the first and second cathodes 14A and 14B and the first top welding section 16 are arranged as concentric circles with respect to each other. In other words, the cathodes of the unit cell 10 can be arranged as concentric circles with respect to each other. Alternatively, as seen in FIG. 3, the first and second cathodes 14A and 14B and the first top welding section 16 are arranged as concentric squares with respect to each other. In other words, the cathodes of the unit cell 10 can alternatively be arranged as concentric squares with respect to each other. It will be apparent to those skilled in the fuel cell art from this disclosure that the unit cell 10 can be modified to include different numbers of interchanging cathode and welding sections as needed and/or desired. It will also be apparent to those skilled in the fuel cell art from this disclosure that the unit cell 10 can be provided with cathodes and welding sections of different shapes of concentric arrangements, such as rectangular, as needed and/or desired.

The top welding section 16 includes a series of welding points to connect the cathodes to the first current collector. The top welding section 16 is a series of coplanar porous layers made of stainless steel. The top welding section 16 preferably has a porosity of 20 percent to 80 percent when it is welded to the first current collector, so as to provide good gas impermeability and strength. The top welding section 16 also preferably has a thickness of 1 to 200 μm upon melting and welding to the first current collector. The top welding section 16 also preferably has a melting point of 1,200° C. or less.

The unit cell 10 of the illustrated embodiment further comprises a gadolinium-doped ceria (GDC) layer. The GDC layer 32 is known alternatively as gadolinia-doped ceria, gadolinium-doped cerium oxide (GCO), cerium-gadolinium oxide (CGO), or cerium (IV) oxide or gadolinium-doped (Gd:CeO₂). The GDC layer 32 can be considered a ceramic electrolyte or a buffer layer between the electrolyte layer 18 and the cathodes to prevent their chemical reaction. The GDC layer 32 can serve as a highly catalyzed oxide ionic conductor to improve oxygen surface reaction rates and accelerated oxygen reduction reaction (ORR).

The electrolyte layer 18 is layered with respect to the cathodes in the stacking direction Z. The electrolyte layer 18 is a dense layer made of ScCeZOx. The electrolyte layer 18 18 includes a solid oxide ceramic material. The electrolyte layer 18 has a thickness of approximately 5-15 μm in the Z-direction (i.e., stacking direction Z). Preferably, the electrolyte layer 18 18 has a thickness of 10 μm or less. The electrolyte layer 18 may be formed via EPD of the solid oxide ceramic material on the top surface of the anode layer 20. By forming the electrolyte layer 18 via EPD, the electrolyte layer 18 can desirably be formed to have a small thickness.

The electrolyte layer 18 can be made of any suitable solid oxide ceramic material. The electrolyte layer 18 can be dense and preferably with a porosity of 1% or less. In this way, the electrolyte layer 18 can be stacked more easily without using adhesives, thereby eliminating the undesirable sealing issues with conventional metal-supported SOFCs. The electrolyte layer 18 is dense to seal the fuel in the anode layer 20 from the air to prevent these elements from interacting. For example, the electrolyte layer 18 can have ScCeSZ. The electrolyte layer 18 can be made with materials selected from the group consisting of doped bismuth oxide, yttria-stabilized zirconia (YSZ), scandia- and yttria-stabilized zirconia (ScYSZ), and scandia-, cerium- and/or yttria-stabilized zirconia (ScCeYSZ).

The unit cell 10 further includes an interfacial layer L that is stacked with respect to the electrolyte layer 18. The interfacial layer L is disposed right below the electrolyte layer 18 along the stacking direction Z. The interfacial layer L is provided as a very thin layer comprising of approximately fifty (50) percent fine metal and fifty (50) percent electrolyte. The electrochemical reaction for fuel oxidation reaction (e.g. hydrogen oxidation reaction) can occur on this interfacial layer. In order to facilitate the electrochemical reactions, the surface of the interfacial layer is coated with catalyst such as NiO—CeO.

As stated previously, the unit cell 10 includes at least one seal. In particular, the unit cell 10 includes a pair of seals 28 disposed on a pair of seal gaps 34, respectively. The seals 28 are adjacent to end ones of the top welding section 16 and are meant to seal opposite ends of the current collector, as seen in FIG. 1. Therefore, the unit cell 10 includes the seal gaps 34 located adjacent to and are coplanar with the first current collector layer 12 in the stacking direction Z. The seal gaps 34 are layered with respect to the electrolyte layer 18. Therefore the seals 28 are stacked above the electrolyte layer 18. The seals 28 are made of any type of elastic or deformable sealing material such as rubber to prevent gas from escaping from either side of the unit cell 10s during stacking.

The anode layer 20 is layered with respect to the electrolyte layer 18 in the stacking direction Z away from the first current collector. The anode layer 20 is preferably a nanofibrous Ni-GDC anode that is made of metal and ceramic. Preferably, the anode layer 20 is approximately 450 μm thick.

The anode layer 20 is formed of a porous anode material that can have a plurality of pores formed therein. The anode layer 20 is preferably formed via EPD of the porous anode material on a metal substrate in the stacking direction Z. The anode layer 20 can include a metal oxide and a solid oxide ceramic material. For example, the metal oxide may be nickel oxide (NiO), and the solid oxide ceramic material may be scandia ceria stabilized zirconia (ScCeSZ) or doped ceria. The anode layer 20 can include approximately forty (40) to sixty (60) percent by volume of NiO and approximately forty (40) to sixty (60) percent by volume of ScCeSZ. The anode layer 20 can include fifty (50) percent by volume of NiO and fifty (50) percent by volume of ScCeSZ. However, the anode layer 20 can also include additives such as tin (Sn). It should be understood that the ScCeSZ material also includes gadolinium (Gd) as a dopant for the ceria (CeOx) in the ScCeSZ material.

Non-limiting examples of materials that can be used to form the anode layer 20 20 can include Ni—YSZ, nickel-gadolinium-doped ceria (Ni-GDC), nickel-samarium-doped ceria (Ni-SDC), Ni—ScYSZ, and perovskite anodes (e.g., SrCo_{0.2}Fe_{0.4}Mo_{0.4}O₃). Therefore, the anode layer 20 20 is provided as a nickel or oxide conductor. The anode layer 20 has oxygen deficient gases like hydrogen and natural gas.

The anode layer 20 can be formed from a ceramic powder material. The powder preferably has a mean particle size of 10 nm to 100 μm, more preferably 50 nm to 50 μm, and still more preferably 100 nm to 10 μm. The mean particle size can be determined according to, for example, JIS Z8901.

The anode layer 20 can be formed using, for example, a mixture of a metal catalyst and a ceramic powder material made of an oxide-ion conductor. Examples of materials usable as the metal catalyst include nickel, iron, cobalt, precious metals (platinum, ruthenium, palladium, and the like), and the like, which are stable in a reducing atmosphere, and have hydrogen oxidation activity. An oxide-ion conductor with the fluorite or perovskite structure is preferably used as the oxide-ion conductor. Examples of oxide-ion conductors with the fluorite structure include ceria-based oxides doped with samarium, gadolinium, and the like, and zirconia-based oxides containing scandium and yttrium. Examples of oxide-ion conductors with the perovskite structure include lanthanum gallate doped with strontium and magnesium. Among these materials, a mixture of an oxide-ion conductor and nickel is preferably used to form the anode layer 20. The mixture of a ceramic material made of an oxide-ion conductor and nickel may be in the form of a physical mixture, or in the form of nickel modified with a powder or a ceramic material modified with nickel. The above-mentioned ceramic materials can be used alone, or two or more of them can be used as a mixture. The anode layer 20 may also be formed using a metal catalyst alone.

The second current collector layer 26 is layered with respect to the anode layer 20 in the direction away from the first current collector layer 12. The reforming catalyst section 22 is layered between the anode layer 20 and the second current collector layer 26 in the stacking direction Z. The reforming catalyst section 22 includes a plurality of at least first and second reforming catalysts 22A and 22B. It will be apparent to those skilled in the fuel cell field from this disclosure that the unit cell 10 can be modified to include a plurality of reforming catalysts 22 of varying quantities as needed and/or desired. Therefore, the unit cell 10 is illustrated as including multiple reforming catalysts 22 beyond just two for illustrative purposes.

The reforming catalyst section 22 is provided as a series of reforming catalysts 22A, 22B, 22C, etc. for alternative fuels. In particular, methane fuel is introduced to the reforming catalyst section 22 from the anode side of the unit cell 10. The reforming catalyst section 22 can reform hydrogen to carbon monoxide and can take hydrogen to interface to where the reaction occurs in the unit cell 10. The reforming catalyst section 22 is also provided with the second current collector layer 26 to improve electrical conductivity between the second current collector layer 26 and the anode layer 20. The second current collector layer 26 also increases conductivity of the reforming catalyst section 22.

The unit cell 10 further comprises the bottom welding section 24. In particular, the unit cell 10 comprises a plurality of bottom welding sections 24 that extend co-planar with respect to each other and co-planar with respect to the reforming catalyst section 22. The bottom welding section 24 extends around an outer circumferential perimeter of the reforming catalyst. As shown, each of the bottom welding sections 24 extends around an outer perimeter of a corresponding one of the reforming catalysts 22A, 22B, 22C, etc. Each of the bottom welding section 24s has at least one welding point that is welded to the second current collector.

That is, the reforming catalyst section 22 is connected to the second current collector layer 26 via the bottom welding sections 24 that are welded to the second current collector layer 26. The bottom welding sections 24 are made of metal and infiltrated with nanoparticles anode. It will be apparent to those skilled in the fuel cell field from this disclosure that the unit cell 10 can be modified to include as many or few bottom welding sections 24 circumferentially surrounding corresponding ones of the reforming catalysts as needed and or desired.

In this way, the unit cell 10 is provided with having metal supported solid oxide electrochemical devices that are all asymmetrically supported. The unit cell 10 is also provided as having an open cathode model to enhance the exposure of the cathodes 14 to external air for better performance, as seen in FIGS. 2 and 3. The cathodes 14 of the unit cell 10 is the active component for oxygen reduction reaction in the SOFCs. The cathodes 14 should also be porous to transport the air for the required electrochemical reaction without mass transfer limitations.

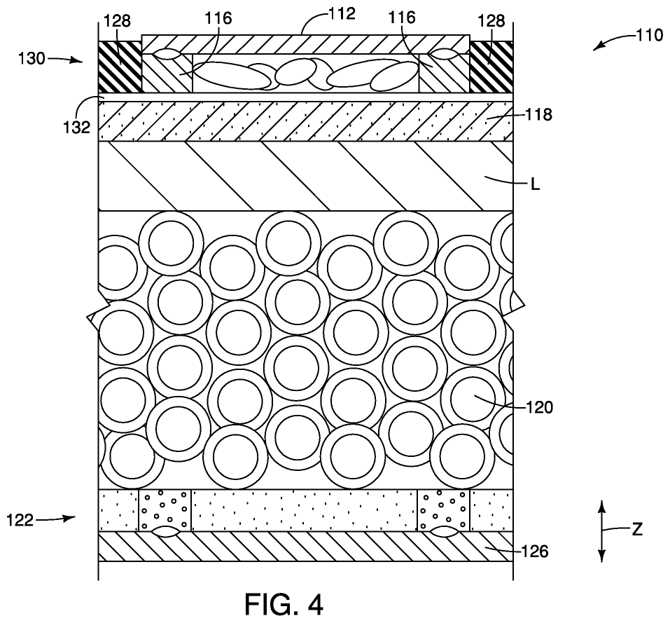

Referring to FIG. 4, a solid oxide electrochemical device (SOFC) that can be modified to be implemented with the unit cell 10 is illustrated. As shown, the SOFC comprises a first (top) current collector layer 112, a cathode 114, a top welding section 116 and an electrolyte layer 118. The SOFC further comprises at least one seal gap 132 for containing a seal 128 therein. The SOFC further includes a second current collector layer 126 and a bottom welding section 124. The components of the SOFC have similar properties to the corresponding components of the unit cell 10 as shown in FIG. 1 and will be described with brevity.

The cathode 114 is layered with respect to the current collector layer 112 in a stacking direction Z of the solid oxide electrochemical device SOFC. The top welding section 116 extends around an outer circumferential perimeter of the cathode 113. The top welding section 116 has at least one welding point that is welded to the first current collector layer 112. The electrolyte layer 118 layered with respect to the first cathode 114A in the stacking direction Z of the SOFC. The seal gap 134 is located adjacent to and coplanar with the first current collector layer 112 in the stacking direction Z and is the seal gap 123 being layered with respect to the electrolyte layer 118. The seal gap 134vis configured to contain a seal 128 for the SOFC to prevent gas leakage.

As shown in FIG. 4, the SOFC further comprises a pair of seals 128 arranged co-planar with the top welding section 116. The arrangement of the claimed unit cell 10 enables for a pair of seals 128 to be arranged to prevent gas from escaping from the SOFC to adjacent SOFC that are used in conjunction with the SOFC or to be stacked with the SOFC. The second current collector layer 26 is arranged opposite with respect to the first current collector layer 112 in the stacking direction Z of the SOFC. The bottom welding section 24 is layered with respect to the second current collector layer 126 in the stacking direction Z towards the first current collector layer 112. The bottom welding section 124 has at least one welding point that is welded to the second current collector. In other words, the bottom welding section 24 is configured to be welded to the second current collector layer 126.

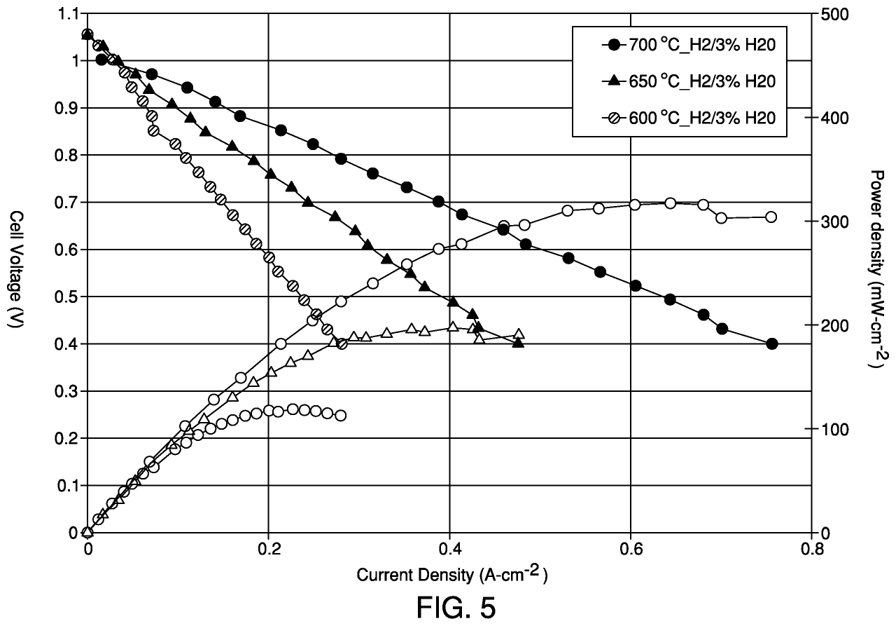

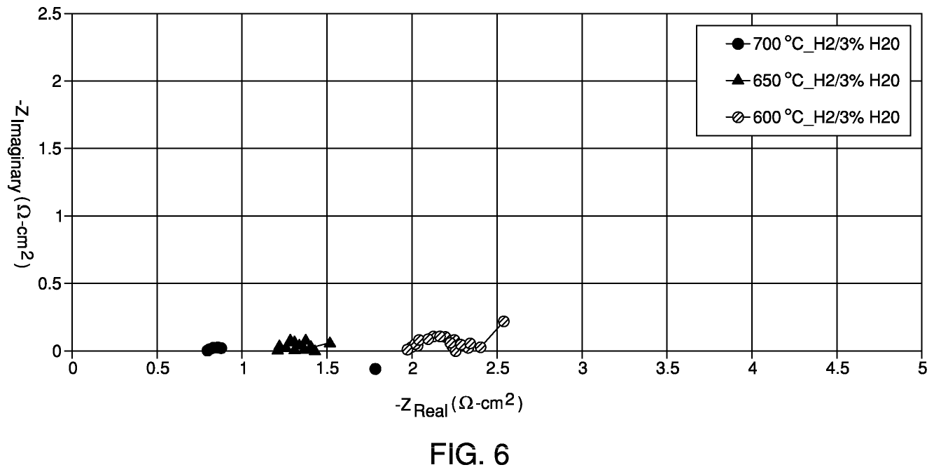

Referring to FIG. 5, a diagram showing voltage generated from the SOFC is illustrated. Referring to FIG. 6, a diagram showing power density generated by the SOFC is illustrated.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a solid oxide electrochemical device unit cell. Accordingly, these terms, as utilized to describe the present invention should be interpreted relative to the solid oxide electrochemical device unit cell.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A cathode structure for use in a solid oxide electrochemical device, the cathode structure comprising:
a first cathode having a center point of the solid oxide fuel cell as viewed in a stacking direction of the solid oxide electrochemical device;
a second cathode concentrically arranged with respect to the first cathode as viewed in the stacking direction; and
a first welding section arranged radially between the first cathode and the second cathode with respect to the center point of the solid oxide electrochemical device, the first welding section extends around an outer circumferential perimeter of the first cathode, the first welding section being configured to be welded to a current collector of the solid oxide electrochemical device.

2. The cathode structure according to claim 1, wherein
the second cathode extends around an outer circumferential perimeter of the first welding section.

3. The cathode structure according to claim 2, further comprising
a third cathode concentrically arranged with respect to the first and second cathodes as viewed in the stacking direction, and
a second welding section arranged radially between the first and second cathodes with respect to the center point of the solid oxide electrochemical device.

4. The cathode structure according to claim 3, wherein
the second welding section extends around an outer circumferential perimeter of the second cathode and is configured to be welded to the current collector of the solid oxide electrochemical device.

5. The cathode structure according to claim 4, wherein
the third cathode extends around an outer circumferential perimeter of the second welding section.

6. The cathode structure according to claim 1, wherein
the first and second cathodes and the first welding section are arranged as concentric squares with respect to each other.

7. The cathode structure according to claim 1, wherein
the first and second cathodes and the first welding section are arranged as concentric circles with respect to each other.

8. The cathode structure according to claim 1, wherein
the first welding section is a porous stainless steel section.

9. A solid oxide electrochemical device, comprising
a first current collector layer;
a cathode that is layered with respect to the current collector layer in a stacking direction of the solid oxide electrochemical device;
a top welding section extending around an outer circumferential perimeter of the first cathode, the top welding section having at least one welding point that is welded to the first current collector;
an electrolyte layer layered with respect to the first cathode in the stacking direction; and
a seal gap located adjacent to and coplanar with the first current collector layer in the stacking direction, the seal gap being layered with respect to the electrolyte layer.

10. The solid oxide electrochemical device according to claim 9, further comprising
a second current collector layer arranged opposite with respect to the first current collector layer in the stacking direction, and
a bottom welding section layered with respect to the second current collector in the stacking direction towards the first current collector, the bottom welding section having at least one welding point that is welded to the second current collector.

11. A solid oxide electrochemical device unit cell comprising:
a first current collector layer;
a first cathode layered with respect to the first current collector layer in a stacking direction of the solid oxide electrochemical device;
a first top welding section extending around an outer circumferential perimeter of the first cathode, the top welding section having at least one welding point that is welded to the first current collector; and
a second cathode that is coplanar with the first cathode in the stacking direction, the top welding section located between the first and second cathodes.

12. The solid oxide electrochemical device unit cell according to claim 11, further comprising
an electrolyte layer layered with respect to the first and second cathodes in the stacking direction, and
a seal that is coplanar with respect to the first current collector layer and being layered with respect to the electrolyte layer.

13. The solid oxide electrochemical device unit cell according to claim 12, wherein
the second cathode is concentrically arranged with respect to the first cathode, and
the first top welding section is arranged radially between the first cathode and the second cathode with respect to a center point of the unit cell, the first top welding section extends around an outer circumferential perimeter of the first cathode.

14. The solid oxide electrochemical device unit cell according to claim 13, wherein
the second cathode extends around an outer circumferential perimeter of the first top welding section.

15. The solid oxide electrochemical device unit cell to claim 14, further comprising
a third cathode concentrically arranged with respect to the first and second cathodes and coplanar with the first and second cathodes in the stacking direction, and
a second top welding section arranged radially between the first and second cathodes with respect to the center point of the unit cell.

16. The solid oxide electrochemical device unit cell according to claim 15, wherein
the second top welding section extends around an outer circumferential perimeter of the second cathode and is configured to be welded to the first current collector of the solid oxide electrochemical device.

17. The solid oxide electrochemical device unit cell according to claim 11, further comprising
an anode layer that is layered with respect to the electrolyte layer in the stacking direction away from the first current collector, and
a second current collector layered with respect to the anode layer in the direction away from the first current collector.

18. The solid oxide electrochemical device unit cell according to claim 17, further comprising
a reforming catalyst section layered between the anode layer and the second current collector in the stacking direction, and
a bottom welding section extending around an outer circumferential perimeter of the reforming catalyst section, the bottom welding section having at least one welding point that is welded to the second current collector.

19. The solid oxide electrochemical device unit cell according to claim 18, wherein
the bottom welding section is made of metal and infiltrated with nanoparticles anode.

20. The solid oxide electrochemical device unit cell according to claim 18, wherein
the first top welding section is a porous stainless steel section.
